(19) United States
(12) Patent Application Publication
(10) Pub. No.: US 2021/0239044 A1
(43) Pub. Date: Aug. 5, 2021

(54) HEAT INSULATING SHEET MEMBER, AN EXHAUST GAS INTRODUCTION PATH AND A TURBOCHARGER

(71) Applicant: 3M INNOVATIVE PROPERTIES COMPANY, St. Paul, MN (US)

(72) Inventor: Shoji Takeuchi, Tokyo (JP)

(21) Appl. No.: 17/251,352

(22) PCT Filed: Jun. 24, 2019
(86) PCT No.: PCT/IB2019/055301

§ 371 Date: Dec. 11, 2020

(30) Foreign Application Priority Data
Jun. 26, 2018 (JP) 2018-121230

(51) Int. Cl. F02C 6/12; F01D 9/02

(52) U.S. Cl. CPC F02C 6/12; F01N 13/141; F01D 9/026

(57) ABSTRACT

A heat insulating sheet member capable of enhancing a heat insulating performance of an exhaust gas introduction path by an easy operation, including such a path in a turbocharger. The heat insulating sheet member is a bendable member formed from an inorganic flexible material. The heat insulating sheet member includes a first region corresponding to an inlet of a bottom wall portion, a second region corresponding to at least a terminating end portion of the scroll portion, a third region provided between the first region and the second region and corresponding to a coupling wall portion, and a fourth region corresponding to an outer peripheral wall portion. The first region and the third region, the third region and the second region, and the first region and the fourth region are coupled to each other with the inorganic flexible material in a continuous state.

### TECHNICAL FIELD

The present invention relates to a heat insulating sheet member and an exhaust gas introduction path (e.g., as found in a turbocharger) heat insulated with the heat insulating sheet member.

### BACKGROUND ART

A turbocharger for an internal combustion engine includes a turbine housing that forms an exhaust gas introduction path. Further, an inner shell is disposed inside the turbine housing. Among such turbochargers, there are known the turbochargers described in Patent JP H07-139364 A and Patent JP 2004-145300 A. The turbocharger of Patent JP H07-139364 A includes a heat insulating layer between the turbine housing and the inner shell for suppressing a decrease in the temperature of an exhaust gas. Patent JP 2004-145300 A suggests forming an air layer by providing a gap between a heat insulating plate of the turbocharger and an inner wall of the turbine housing.

### SUMMARY OF THE INVENTION

When a heat insulating portion is formed between the turbine housing and the inner shell, it is necessary to dispose a material for heat insulation having high workability while ensuring a sufficient heat insulating performance. That is, there is a demand to enhance the heat insulating performance of the exhaust gas introduction path (e.g., of a turbocharger) with an easy operation.

A heat insulating sheet member according to an aspect of the present invention is a heat insulating sheet member operatively adapted (i.e., dimensioned, design and/or configured) for being disposed on an inner side of a housing (e.g., a turbine housing) forming an exhaust gas introduction flow path, e.g., of a turbocharger. The housing includes an outer peripheral wall portion and an inner peripheral wall portion extending along a central axis and a bottom wall portion provided on a first side in an axial direction, the axial direction being an extending direction of the central axis, and an exhaust gas introduction portion is formed in a portion of the outer peripheral wall portion in a circumferential direction and configured to introduce exhaust gas into the housing. The bottom wall portion includes an inlet of the exhaust gas introduction flow path formed at a position corresponding to the exhaust gas introduction portion in the circumferential direction, and a scroll portion extending in a spiral manner about the central axis from an upstream side to a downstream side of the exhaust gas introduction flow path. The scroll portion includes a terminating end portion disposed on a second side in the axial direction from the inlet. The terminating end portion of the scroll portion and the inlet are coupled by a coupling wall portion extending in the axial direction. The inner shell is disposed on an inner side of the housing and includes an inner shell outer peripheral wall portion, an inner shell inner peripheral wall portion, an inner shell bottom wall portion, and an inner shell coupling wall portion corresponding to the outer peripheral wall portion, the inner peripheral wall portion, the bottom wall portion, and the inner shell coupling wall portion of the housing. The heat insulating sheet member is configured as a bendable member formed from an inorganic flexible material and includes a first region corresponding to at least an edge portion on an inlet side of the exhaust gas introduction flow path in the inner shell bottom wall portion, a second region corresponding to at least the terminating end portion of the scroll portion, a third region provided between the first region and the second region and corresponding to at least the coupling wall portion, and a fourth region corresponding to at least an edge portion on the inlet side of the exhaust gas introduction flow path in the inner shell outer peripheral wall portion. The first region and the third region, the third region and the second region, and the first region and the fourth region are coupled to each other with the inorganic flexible material in a continuous state.

The heat insulating sheet member according to another aspect of the present invention includes the first region corresponding to at least the edge portion on the inlet side of the exhaust gas introduction flow path in the inner shell bottom wall portion, the second region corresponding to at least the terminating end portion of the scroll portion, the third region provided between the first region and the second region, and corresponding to at least the coupling wall portion, and the fourth region corresponding to at least an edge portion on the inlet of the exhaust gas introduction flow path in the inner shell outer peripheral wall portion. The exhaust gas introduction portion is a portion configured to introduce high-temperature exhaust gas into the housing. Therefore, by insulating the configuration around the exhaust gas introduction portion, it is possible to enhance the heat insulating performance of the exhaust gas flow path. The heat insulating sheet member can insulate the configuration in the vicinity of the inlet of the exhaust gas introduction flow path by the first region to the fourth region. Therefore, the heat insulating sheet member can enhance the heat insulating performance of the exhaust gas introduction flow path. Furthermore, the heat insulating sheet member is a bendable member formed from an inorganic flexible material. Further, the first region and the third region, the third region and the second region, and the first region and the fourth region are coupled to each other with the inorganic flexible material in a continuous state. Therefore, an operator can treat the first region to the fourth region as a single sheet member, and the heat insulating operation of the housing is completed by simply bending and arranging the sheet member. From the above, the heat insulating performance of the exhaust gas introduction path can be enhanced by an easy operation.

In the heat insulating sheet member, the first region may include a first expansion region. The first expansion region may be provided protruding from a region corresponding to the inlet of the first region and correspond to a portion of the bottom wall portion downstream of the exhaust gas introduction flow path relative to the inlet.

The second region may extend in an arc shape along the scroll portion of the bottom wall portion.

In the heat insulating sheet member, the fourth region may include a fourth expansion region. The fourth expansion region may be provided extending from an adjacent region of the fourth region adjacent to the first region and correspond to a portion of the outer peripheral wall portion further downstream of the exhaust gas introduction flow path than a location corresponding to the adjacent region.

In the heat insulating sheet member, the third region may include a third expansion region. The third expansion region may be provided extending from a region of the third region corresponding to the coupling wall portion and correspond to a portion of the inner peripheral wall portion extending downstream of the exhaust gas introduction flow path from the coupling wall portion.

The heat insulating sheet member may further include a fifth region provided radially extending from the second region having an arc shape to an outer peripheral side and corresponding to a portion of the outer peripheral wall portion further downstream of the exhaust gas introduction flow path than a location corresponding to the fourth region.

The heat insulating sheet member may further include a sixth region provided extending from the second region having an arc shape to an inner peripheral side and corresponding to a portion of the inner peripheral wall portion extending from the coupling wall portion to the downstream side of the exhaust gas introduction flow path.

### Effect of the Invention

According to one aspect of the present invention, it is possible to enhance a heat insulating performance of an exhaust gas introduction path by an easy operation.

### BRIEF DESCRIPTION OF THE DRAWINGS

FIG. 1 is a plan view of a configuration on an exhaust side of a turbocharger as viewed from an axial direction.

FIG. 2 is a development perspective view of a configuration on an exhaust side of a turbocharger.

FIG. 3 is a cross-sectional view along line in FIG. 1.

FIG. 4 is a plan view of a heat insulating sheet member according to an embodiment of the present invention.

FIG. 5 is a perspective view illustrating the heat insulating sheet member illustrated in FIG. 4 incorporated into a turbine housing.

FIG. 6 is a perspective view illustrating the heat insulating sheet member illustrated in FIG. 4 incorporated into a turbine housing.

FIG. 7 is a plan view of a heat insulating sheet member according to a modified example.

FIG. 8 is a perspective view illustrating the heat insulating sheet member illustrated in FIG. 7 incorporated into a turbine housing.

FIG. 9 is a plan view of a heat insulating sheet member according to a modified example.

FIG. 10 is a plan view of a heat insulating sheet member according to a modified example.

FIG. 11 is a perspective view illustrating the heat insulating sheet member illustrated in FIG. 10 incorporated into a turbine housing.

FIG. 12 is a plan view of a heat insulating sheet member according to a modified example.

FIG. 13 is a plan view of a heat insulating sheet member according to a modified example.

FIG. 14 is a plan view of a heat insulating sheet member according to a modified example.

FIG. 15 is a plan view of a heat insulating sheet member according to a modified example.

FIG. 16 is a plan view of a heat insulating sheet member according to a modified example.

FIG. 17 is a development view of a configuration on an exhaust side of a turbocharger according to a modified example.

### DESCRIPTION OF EMBODIMENTS

Detailed descriptions of various embodiments according to the present invention are given below with reference to the attached drawings. Note that, in the description of the drawings, identical elements are denoted using the same reference numerals, and duplicate descriptions thereof are omitted.

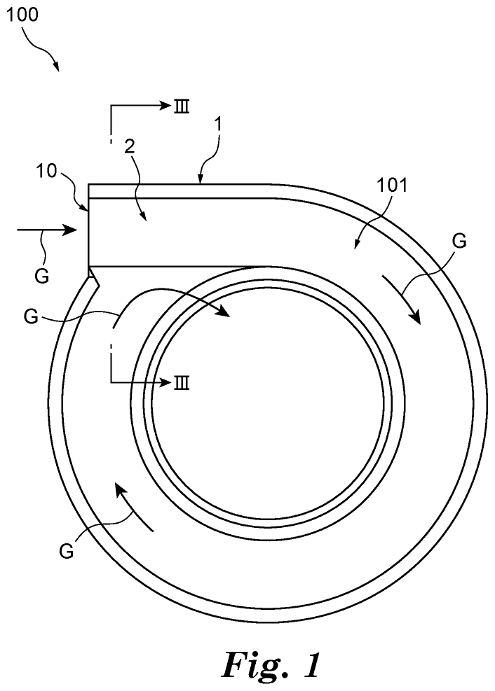

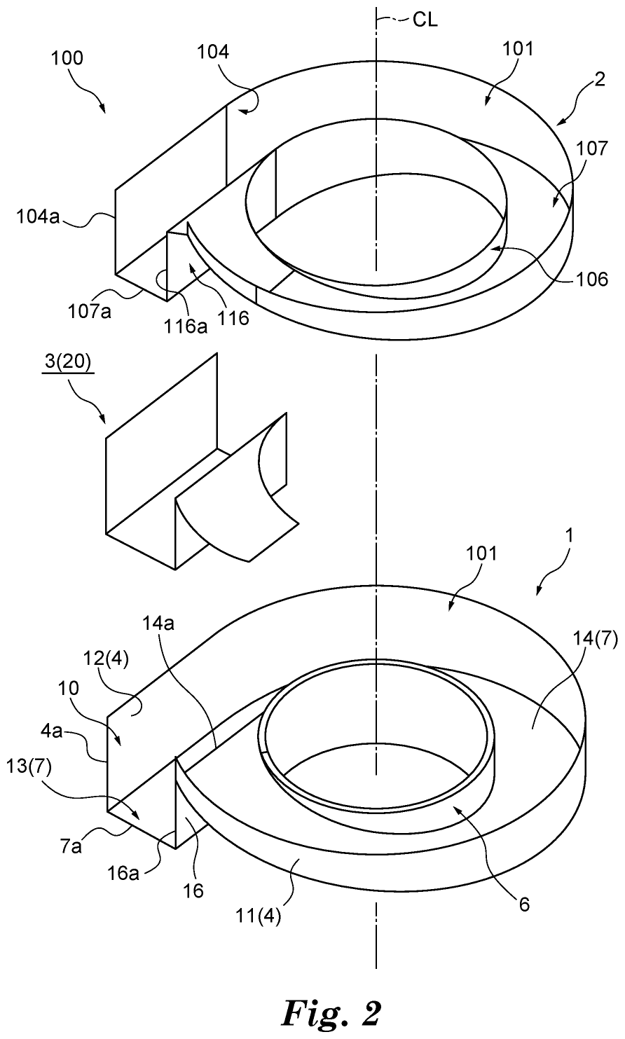

A heat insulating sheet member 20 according to an embodiment of the present invention is a member disposed on an inner side of a turbine housing 1 that forms an exhaust gas introduction flow path 101 of a turbocharger 100. The heat insulating sheet member 20 constitutes a heat insulating member 3 by being bent. The heat insulating sheet member 20, in the state of the heat insulating member 3, is disposed inside the turbine housing 1. As illustrated in FIG. 1 and FIG. 2, a structure on an exhaust side of the turbocharger 100 includes the turbine housing 1, an inner shell 2, and the heat insulating member 3.

The turbine housing 1 mainly includes an outer peripheral wall portion 4, an inner peripheral wall portion 6, and a bottom wall portion 7. The turbine housing 1 has a shape that forms a circle about a central axis CL. That is, the exhaust gas introduction flow path 101 formed by the turbine housing 1 is a flow path that pivots about the central axis CL. An inner side in a radial direction with reference to the central axis CL is referred to as an “inner periphery”, and an outer side in the radial direction is referred to as an “outer periphery.” Further, in an axial direction in which the central axis CL extends, the bottom wall portion 7 side is referred to as a “bottom side”, and a side opposite to the bottom wall portion 7 is referred to as an “top side”. Here, “bottom side” and “top side” are established for the sake of convenience in the specification herein and are not intended to limit a posture during use of the turbocharger 100.

The outer peripheral wall portion 4 is a wall portion that forms a circle about the central axis CL and extends along the central axis CL. An exhaust gas introduction portion 10 that introduces exhaust gas into the turbine housing 1 is formed in a portion of the outer peripheral wall portion 4 in a circumferential direction. The exhaust gas introduction portion 10 is an opening formed by interruption of the outer peripheral wall portion 4 in the circumferential direction. Note that, in the present embodiment, when viewed from the top side toward the bottom side in the axial direction, an exhaust gas G introduced from the exhaust gas introduction portion 10 pivots clockwise inside the turbine housing 1. In the following description, the words “upstream” and “downstream” are used with reference to a flow of the exhaust gas G.

The outer peripheral wall portion 4 includes a pivoting portion 11 and a guide 12. The pivoting portion 11 is a portion that pivots about the central axis CL so as to form an arc. The guide 12 is a portion that extends straight from the exhaust gas introduction portion 10 and guides the exhaust gas to the pivoting portion 11. The guide 12 extends straight so as to be perpendicular to the central axis CL at a position spaced apart from the central axis CL on the outer peripheral side. The exhaust gas introduction portion 10 is formed on a first end side of the guide 12. A second end side of the guide 12 is connected to an end portion on the upstream side of the pivoting portion 11. The guide 12 extends in a direction tangential to the pivoting portion 11. However, the direction in which the guide 12 extends is not particularly limited to a specific direction, and the guide 12 may extend in a direction inclined relative to a tangent of the pivoting portion 11. The pivoting portion 11 pivots substantially once about the central axis CL from the second end side of the guide 12. An end portion, that is, a terminating end portion, on the downstream side of the pivoting portion 11 is disposed at the position of the exhaust gas introduction portion 10.

The inner peripheral wall portion 6 is a wall portion that forms a circle about the central axis CL and extends along the central axis CL. The inner peripheral wall portion 6 is a cylindrical member provided at a position spaced apart from the outer peripheral wall portion 4 to the inner peripheral side. A space is formed on the inner peripheral side of the inner peripheral wall portion 6. A rotating shaft and an impeller (not illustrated) of the turbocharger 100 are disposed in the space.

The bottom wall portion 7 is a wall portion provided on the bottom side (a first side) in the axial direction. That is, the bottom wall portion 7 is a wall portion that connects the end portions on the bottom side of the outer peripheral wall portion 4 and the inner peripheral wall portion 6 in the axial direction and covers the gap therebetween. Note that an area between the end portions on the top side of the outer peripheral wall portion 4 and the inner peripheral wall portion 6 in the axial direction is open. However, the area between the end portions is blocked by another member. As a result, the space surrounded by the bottom wall portion 7, the outer peripheral wall portion 4, the inner peripheral wall portion 6, and another member forms the exhaust gas introduction flow path 101. The bottom wall portion 7 includes an inlet 13 and a scroll portion 14.

The inlet 13 constitutes an inlet of the exhaust gas introduction flow path 101 formed at a position corresponding to the exhaust gas introduction portion 10 in the circumferential direction. In the present embodiment, a portion extending straight from the exhaust gas introduction portion 10 together with the guide 12 of the outer peripheral wall portion 4 corresponds to the inlet 13. The exhaust gas introduction portion 10 is formed on a first end side of the inlet 13. The second end side of the inlet 13 is connected to an end portion on the upstream side of the scroll portion 14. The inlet 13 extends straight from the exhaust gas introduction portion 10 and guides the exhaust gas to the scroll portion 14. The end portion on the outer peripheral side of the inlet 13 is coupled to an end portion on the bottom side of the guide 12. The inlet 13 constitutes a plane extending in a direction perpendicular to the central axis CL.

The scroll portion 14 is a portion of the bottom wall portion 7 and extends in a spiral manner about the central axis CL from the upstream side to the downstream side of the exhaust gas introduction flow path 101. The scroll portion 14 pivots about the central axis CL so as to form an arc. The scroll portion 14 pivots substantially once about the central axis CL from the second end side of the inlet 13. An end portion, that is, a terminating end portion 14a, on the downstream side of the scroll portion 14 is disposed at the position of the exhaust gas introduction portion 10. The terminating end portion 14a of the scroll portion 14 is disposed at the position of the end portion on the inner peripheral side of the inlet 13. The scroll portion 14 is gradually inclined so as to be disposed on the top side (the second side) in the axial direction from the end portion on the upstream side thereof toward the terminating end portion 14a. The end portion on the upstream side of the scroll portion 14 is disposed in the same position as that of the inlet 13 in the axial direction. The terminating end portion 14a of the scroll portion 14 is disposed above the inlet 13 in the axial direction. Note that the position at which the inclination of the bottom wall portion 7 starts need not be the end portion on the upstream side of the scroll portion 14. The inclination may start from the inlet 13 or may start from a position slightly downstream from the end portion on the upstream side of the scroll portion 14.

The end portion on the upstream side and the end portion on the downstream side of the scroll portion 14 and the pivoting portion 11 are disposed in the same position. The end portion on the outer peripheral side of the scroll portion 14 is coupled to an end portion on the bottom side of the pivoting portion 11. The end portion on the inner peripheral side of the scroll portion 14 is coupled to an outer peripheral surface of the inner peripheral wall portion 6. Note that the end portion on the top side of the pivoting portion 11 is disposed at a fixed position above the terminating end portion 14a in the axial direction. The end portion on the top side of the inner peripheral wall portion 6 is disposed at a fixed position substantially the same as that of the terminating end portion 14a in the axial direction. On the other hand, the end portion on the bottom side of the pivoting portion 11 is inclined so as to correspond to the inclination of the scroll portion 14. Therefore, a dimension in the axial direction of the pivoting portion 11 gradually decreases from the upstream side toward the downstream side. Further, a dimension in the axial direction of a portion of the inner peripheral wall portion 6 projecting above the scroll portion 14 gradually decreases from the upstream side toward the downstream side.

The terminating end portion 14a of the scroll portion 14 and the inlet 13 are coupled by a coupling wall portion 16 extending in the axial direction. The coupling wall portion 16 couples the terminating end portion 14a and the end portion on the inner peripheral side of the inlet 13. In the present embodiment, the coupling wall portion 16 extends perpendicular to the inlet 13. However, the angle of the coupling wall portion 16 need not be perpendicular, and may be somewhat inclined with respect to the inlet 13. The terminating end portion 14a, the end portion on the inner peripheral side of the inlet 13, and the coupling wall portion 16 extend straight from the exhaust gas introduction portion 10 and are coupled to the inner peripheral wall portion 6. The terminating end portion 14a, the end portion on the inner peripheral side of the inlet 13, and the coupling wall portion 16 extend in a direction tangential to the inner peripheral wall portion 6. Thus, the terminating end portion 14a, the end portion on the inner peripheral side of the inlet 13, and the coupling wall portion 16 extend parallel with the guide 12. However, the direction in which the terminating end portion 14a, the end portion on the inner peripheral side of the inlet 13, and the coupling wall portion 16 extend is not particularly limited to a specific direction and may be a direction inclined relative to a tangent of the inner peripheral wall portion 6.

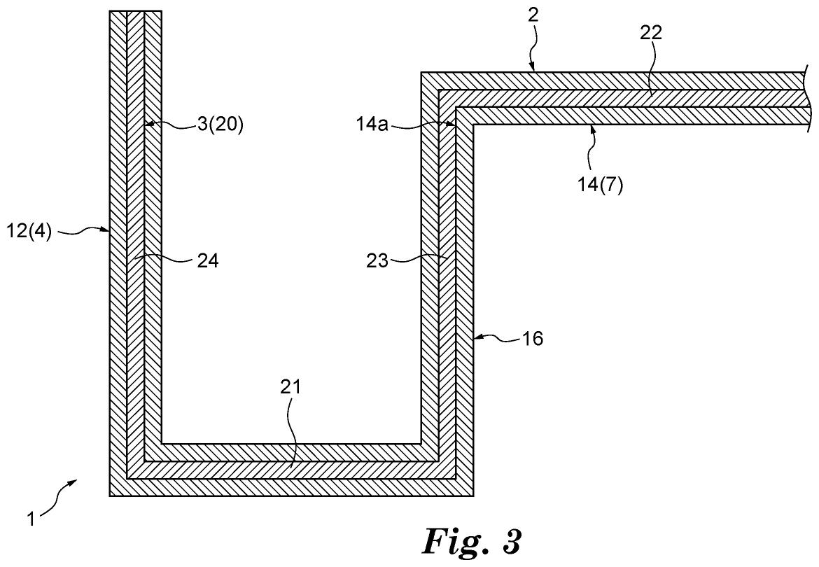

The inner shell 2 is a member disposed inside the turbine housing 1. The inner shell 2 has a configuration substantially similar to that of the turbine housing 1. As illustrated in FIG. 2, the inner shell 2 includes an inner shell outer peripheral wall portion 104, an inner shell inner peripheral wall portion 106, an inner shell bottom wall portion 107, and an inner shell coupling wall portion 116 corresponding to the outer peripheral wall portion 4, the inner peripheral wall portion 6, and the bottom wall portion 7 of the turbine housing 1. The inner shell outer peripheral wall portion 104, the inner shell inner peripheral wall portion 106, the inner shell bottom wall portion 107, and the inner shell coupling wall portion 116 each have a shape similar to that of the outer peripheral wall portion 4, the inner peripheral wall portion 6, the bottom wall portion 7, and the coupling wall portion 16 except that the sizes are slightly smaller so that the inner shell 2 can be disposed inside the turbine housing 1. The inner shell outer peripheral wall portion 104, the inner shell bottom wall portion 107, and the inner shell coupling wall portion 116 include edge portions 104a, 107a, 116a on the inlet side of the exhaust gas introduction flow path 101. Note that, in the present specification, the edge portions 104a, 107a, 116a do not denote only the edge (end portion) of each wall portion, but indicate a region offset from that edge toward the downstream side by a predetermined distance. Specifically, a region offset from the edge of each wall portion by a dimension equivalent to, at most, half a width dimension of the inner shell bottom wall portion 107 in the vicinity of the inlet is included in the edge portions 104a, 107a, 116a. The edge portion 104a of the inner shell outer peripheral wall portion 104 extends in a vertical direction at a position on the most upstream side in a region corresponding to the guide 12 of the outer peripheral wall portion 4. The edge portion 107a of the inner shell bottom wall portion 107 extends in a width direction at a position on the most upstream side in a region corresponding to the inlet 13 of the bottom wall portion 7. The edge portion 116a of the inner shell coupling wall portion 116 extends in the vertical direction at a position on the most upstream side of the inner shell coupling wall portion 116. In this embodiment, in a state in which the inner shell 2 is incorporated into the turbine housing 1, the edge portions 104a, 107a, 116a are disposed at the same positions as those of the edge portions 4a, 7a, 16a on the inlet side of the exhaust gas introduction flow path 101 of the outer peripheral wall portion 4, the bottom wall portion 7, and the coupling wall portion 16. As illustrated in FIG. 3, a slight gap is formed between the inner shell 2 and the turbine housing 1. In a region in the vicinity of the exhaust gas introduction portion 10, the heat insulating member 3 is disposed so as to fill a gap between the turbine housing 1 and the inner shell 2.

With the heat insulating member 3 and the inner shell 2 incorporated into the turbine housing 1 as described above, a structure on the exhaust side of the turbocharger 100 is formed. As illustrated in FIG. 1, the exhaust gas G is introduced into the turbine housing 1 from the exhaust gas introduction portion 10. The exhaust gas G passes through the exhaust gas introduction flow path 101 at locations corresponding to the inlet 13, the guide 12, and the coupling wall portion 16 and pivots inside the exhaust gas introduction flow path 101 at locations corresponding to the scroll portion 14, the pivoting portion 11, and the inner peripheral wall portion 6. Subsequently, the exhaust gas G is discharged to the space on the inner peripheral side of the inner peripheral wall portion 6 in the vicinity of the terminating end portion 14a.

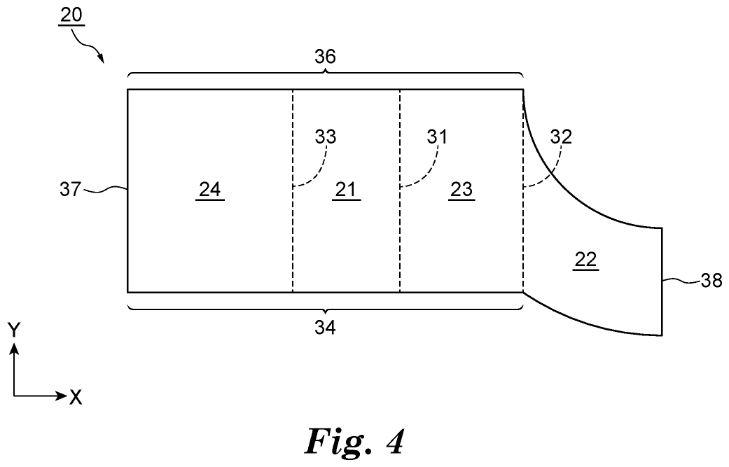

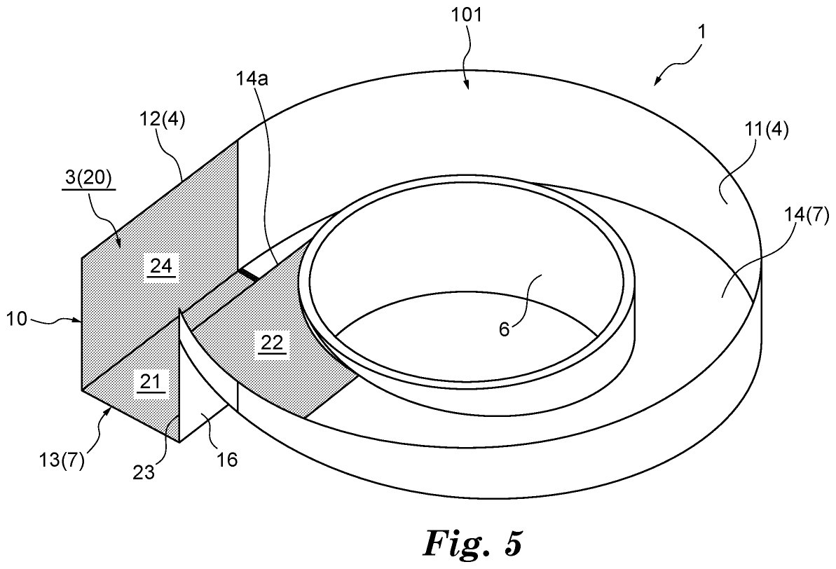

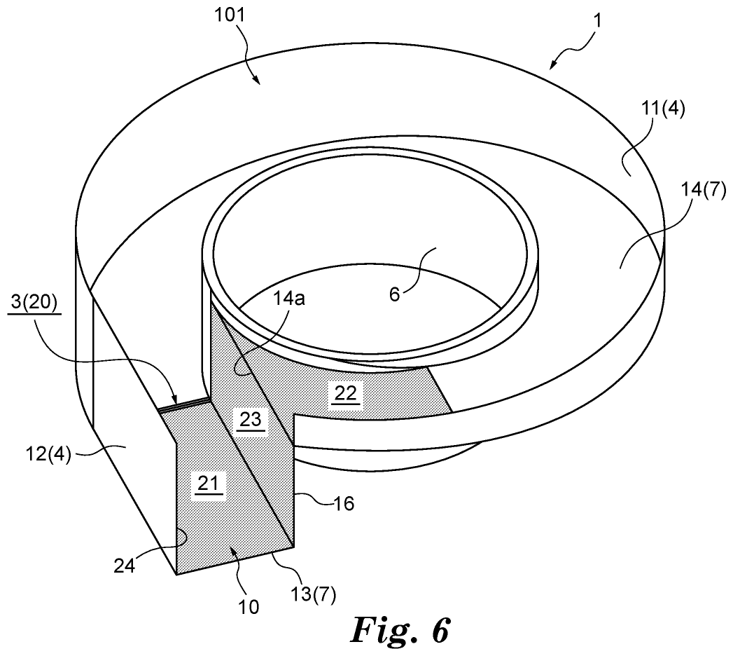

Next, a configuration of the heat insulating sheet member 20 will be described with reference to FIGS. 4 to 6. The heat insulating sheet member 20 is a bendable member formed from an inorganic flexible material and an organic binder. Note that in FIG. 5 and FIG. 6, the portion corresponding to the heat insulating member 3 is imparted with a grayscale. A material that is easy to bend and has high heat insulation properties is adopted as the inorganic flexible material. Examples of such an inorganic flexible material include alumina fiber, ceramic fiber, silica wool, glass wool, and rock wool. The organic binder is used to maintain the inorganic flexible material in a sheet shape and to facilitate the attachment operation, and the organic binder used is appropriately selected from or obtained by combining various rubbers, thermoplastic resins, and thermosetting resins.

The heat insulating sheet member 20 includes a region (first region) 21, a region (second region) 22, a region (third region) 23, and a region (fourth region) 24. The region 21 is a region corresponding to at least the edge portion 104a on the inlet side of the exhaust gas introduction flow path 101 in the inner shell bottom wall portion 107. Further, the region 21 is a region corresponding to the inlet 13 of the bottom wall portion 7. That is, in a case that the heat insulating member 3 is formed by the heat insulating sheet member 20 and disposed inside the turbine housing 1, the region 21 is disposed covering the inner surface of the inlet 13. Further, the region 21 is disposed covering an outer surface of the portion corresponding to the inlet 13 in the inner shell bottom wall portion 107. In this way, the region 21 is disposed at least in a region in the vicinity of the edge portions 4a, 104a. Note that, in the following description, a region referred to as “corresponding to a wall portion of the turbine housing,” means that the region is disposed covering an inner surface of the wall portion in a case that the heat insulating member 3 is formed by the heat insulating sheet member 20 and disposed in the turbine housing 1. Similarly, a region is referred to as “corresponding to a wall portion of the inner shell” means that the region is disposed covering an outer surface of the wall portion in the inner shell 2 in a case that the heat insulating member 3 is formed by the heat insulating sheet member 20 and disposed between the turbine housing 1 and the inner shell 2. Similarly, a region referred to as “corresponding to an edge portion of the inner shell” means that the region is disposed covering an outer surface of the wall portion in a predetermined region in the vicinity of the edge portion of the wall portion of the inner shell 2 in a case that the heat insulating member 3 is formed by the heat insulating sheet member 20 and disposed between the turbine housing 1 and the inner shell 2. The region 22 is a region corresponding to at least the terminating end portion 14a of the scroll portion 14. The region 23 is a region corresponding to the coupling wall portion 16. Further, the region 24 is a region corresponding to at least the edge portion 116a on the inlet side of the exhaust gas introduction flow path 101 in the inner shell coupling wall portion 116. Note that, in the following, descriptions are given with the X axis and the Y axis established. The X-axis direction is the direction corresponding to the width direction of the region 21, and the inner peripheral side thereof in a case that the heat insulating sheet member 20 is disposed in the inlet 13 is the positive side in the X-axis direction. The Y-axis is the direction corresponding to the length direction of the region 21, and the downstream side thereof in a case that the heat insulating sheet member 20 is disposed in the inlet 13 is the positive side in the Y-axis direction.

As illustrated in FIG. 4, the region 23 is disposed at a position adjacent to the positive side in the X-axis direction relative to the region 21. The region 22 is disposed at a position adjacent to the positive side in the X-axis direction relative to the region 23. Thus, the region 23 is provided between the region 21 and the region 22. The region 24 is disposed at a position adjacent to the negative side in the Y-axis direction relative to the region 21. The region 24 is a region corresponding to at least the edge portion 104a on the inlet side of the exhaust gas introduction flow path 101 in the inner shell outer peripheral wall portion 104. Further, the region 21 and the region 23, the region 23 and the region 22, and the region 21 and the region 24 are coupled to each other with the inorganic flexible material in a continuous state. The region 21 and the region 23 are coupled to each other at a boundary portion 31. The region 23 is bent at the boundary portion 31 so as to stand vertically from the region 21. The region 23 and the region 22 are coupled to each other at a boundary portion 32. The region 22 is bent at the boundary portion 32 so as to curve relative to the region 23. The region 21 and the region 24 are coupled to each other at a boundary portion 33. The region 24 is bent at the boundary portion 33 so as to stand vertically from the region 21.

Note that the state in which regions are “coupled to each other with the inorganic flexible material in a continuous state” refers to a state in which the regions can be treated as a single sheet without separation. Further, in this state, the inorganic flexible material constituting one region extends continuously to the other region. Note that a state in which one region and another region are temporarily cut at the boundary portion and connected with tape or the like does not correspond to a state in which the regions are “coupled to each other with the inorganic flexible material in a continuous state.” On the other hand, to facilitate the bending at the boundary portion, a state in which the boundary portion includes a perforation (that is, a state in which the inorganic flexible material is continuous in one portion and cut in another portion) or the like corresponds to state in which the regions are “coupled to each other with the inorganic flexible material in a continuous state.”

In the example illustrated in FIGS. 4 to 6, the region 21 is formed covering the entire area (at least a portion) of the inlet 13. The region 23 is formed covering the entire region of the coupling wall portion 16. The region 24 is formed covering a portion of the outer peripheral wall portion 4 that faces the coupling wall portion 16 across the inlet 13, that is, the entire region (at least a portion) of the guide 12. Therefore, the positions in the Y-axis direction of the end portions of the regions 21, 23, 24 on the negative side in the Y-axis direction are the same. Therefore, the heat insulating sheet member 20 includes a side portion 34 that extends straight in the X-axis direction on the negative side in the Y-axis direction (refer to FIG. 4). The side portion 34 is disposed in the same position as those of the edge portions 4a, 6a, 7a, 104a, 116a, 107a of the turbine housing 1 and the inner shell 2. Note that in the embodiment, the side portion 34 extends straight, but the form in which the side portion 34 extends is not particularly limited to a specific form and may extend in various shapes such as an inclined or curved shape. In the following, including the modified examples, the description “extends straight” may be used in relation to a side portion, an end portion, or the like, but these portions may extend in a non-straight manner. The side portion 34 is configured by combining the end portions of the regions 21, 23, 24 on the negative side in the Y-axis direction. The positions of the end portions on the positive side of the regions 21, 23, 24 in the Y-axis direction are the same. Thus, the heat insulating sheet member 20 includes a side portion 36 that extends straight in the X-axis direction on the positive side in the Y-axis direction (refer to FIG. 4). The side portion 36 is configured by combining the end portions of the regions 21, 23, 24 on the positive side in the Y-axis direction. The heat insulating sheet member 20 includes a side portion 37 that extends straight in the Y-axis direction on the negative side in the X-axis direction (refer to FIG. 4). The side portion 37 is configured by the end portion on the negative side of the region 24 in the X-axis direction.

Note that, the examples illustrated in the drawings of the present embodiment illustrate a configuration in which the side portion 34 of the heat insulating sheet member 20 is disposed at the same position as those of, among the edge portions 104a, 107a, 116a of the inner shell 2, the edge (end portion) of the wall portion. As a result, the regions 21, 23, 24 cover the entire region of the inlet 13, the entire region of the coupling wall portion 16, and the entire region of the guide 12. However, as described above, the edge portions 104a, 107a, 116a denote only the region offset from the edge of the respective wall portions toward the downstream side by a predetermined distance. Therefore, the side portion 34 of the heat insulating sheet member 20 may not be disposed completely in the same position as that of the edge of each wall portion, or may be disposed at a position offset from the edge. As a result, the regions 21, 23, 24 need only cover a portion of the inlet 13, a portion of the coupling wall portion 16, and a portion of the guide 12. Even with such a configuration, the region 21 applies to the region corresponding to the edge portion 104a on the inlet side of the exhaust gas introduction flow path 101 in the inner shell bottom wall portion 107, and the region 24 applies to the region corresponding to the edge portion 104a on the inlet side of the exhaust gas introduction flow path 101 in the inner shell outer peripheral wall portion 104.

In a case that the side portion 34 of the heat insulating sheet member 20 is disposed at a position offset from the edge of each wall portion, a configuration such as the following may be adopted. For example, the edge vicinity on the upstream side of the inner shell outer peripheral wall portion 104, the inner shell bottom wall portion 107, and the inner shell coupling wall portion 116 of the inner shell 2 may be bent toward the turbine housing 1. The amount of such bending is preferably equivalent to a thickness of the heat insulating sheet member 20. Alternatively or in addition, the outer peripheral wall portion 4, the bottom wall portion 7, and the coupling wall portion 16 of the turbine housing 1 may include a recessed portion in which the heat insulating sheet member 20 can be housed. A depth of such a recessed portion is preferably equivalent to the thickness of the heat insulating sheet member 20. According to these configurations, the vicinity of the side portion 34 of the heat insulating sheet member 20 is covered in the edge vicinity on the upstream side of the turbine housing 1 and the inner shell 2, making it possible to keep the exhaust gas G from directly coming into contact with the heat insulating sheet member 20. As a result, degradation of the heat insulating sheet member 20 can be suppressed.

The region 22 is formed covering a portion including the terminating end portion 14a of the scroll portion 14 and separated by a fixed distance from the terminating end portion 14a to the upstream side. The region 22 has an arc shape. The heat insulating sheet member 20 includes a side portion 38 that extends in the Y-axis direction on the positive side in the X-axis direction (refer to FIG. 4). The side portion 38 is configured by the end portion on the positive side of the region 22 in the X-axis direction. The side portion 38 (that is, the length of the region 22) is set to a position obtained by moving the region 22 in a 90° counterclockwise direction about the central axis of the arc using the side portion 36 as a reference. However, the position of the side portion 38 is not particularly limited to a specific position, and the side portion 38 may be disposed at a position closer to the terminating end portion 14a, or may be disposed at a position farther away from the terminating end portion 14a.

Next, the action and effect of the heat insulating sheet member 20 according to the present embodiment will be described.

The heat insulating sheet member 20 includes the region 21 corresponding to at least the edge portion 107a on the inlet side of the exhaust gas introduction flow path 101 in the inner shell bottom wall portion 107, the region 22 corresponding to at least the terminating end portion 14a of the scroll portion 14, the region 23 provided between the region 21 and the region 22 and corresponding to the coupling wall portion 16, and the region 24 corresponding to at least an edge portion 104a on the inlet side of the exhaust gas introduction flow path 101 in the inner shell outer peripheral wall portion 104. The exhaust gas introduction portion 10 is a portion configured to introduce high-temperature exhaust gas into the turbine housing 1. Therefore, by insulating the configuration around the exhaust gas introduction portion 10, it is possible to enhance the heat insulating performance of the exhaust gas introduction flow path 101. The heat insulating sheet member 20 can insulate the inlet 13, the terminating end portion 14a of the scroll portion 14, the coupling wall portion 16, and the outer peripheral wall portion 4 configured around the exhaust gas introduction portion 10, by the region 21 to the region 24. Therefore, the heat insulating sheet member 20 can enhance the heat insulating performance of the exhaust gas introduction flow path 101. Furthermore, the heat insulating sheet member 20 is a bendable member formed from an inorganic flexible material. Further, the region 21 and the region 23, the region 23 and the region 22, and the region 21 and the region 24 are coupled to each other with the inorganic flexible material in a continuous state. Therefore, an operator can treat the region 21 to the region 24 as a single sheet member, and the heat insulating operation of the turbine housing 1 is completed by simply bending and arranging the sheet member. From the above, the heat insulating performance of the exhaust gas introduction flow path 101 can be enhanced by an easy operation.

Further, in a dual structure in which the turbine housing 1 and the inner shell 2 are overlapped, problems with exhaust gas leakage through a gap between the turbine housing 1 and the inner shell 2 can occur. In particular, the terminating end portion 14a, which is a terminating end of the exhaust gas flow, is also disposed in the vicinity of the exhaust gas introduction portion 10 into which the exhaust gas is introduced. In this manner, a sealing property needs to be ensured at locations where a starting end and a terminating end of the exhaust gas flow are densely arranged. In contrast, with the heat insulating sheet member 20 according to the present embodiment, the region 21, the region 22, and the region 23 are disposed covering the inlet 13, the coupling wall portion 16, and the terminating end portion 14a, making it possible to ensure the seal property at these locations. Furthermore, since the region 21, the region 22, and the region 23 are coupled to each other with the inorganic flexible material in a continuous state, a more enhanced sealing property can be exhibited as compared to a case that a sealing member cut on a per region basis is arranged.

The present invention is not intended to be limited to the embodiments described above.

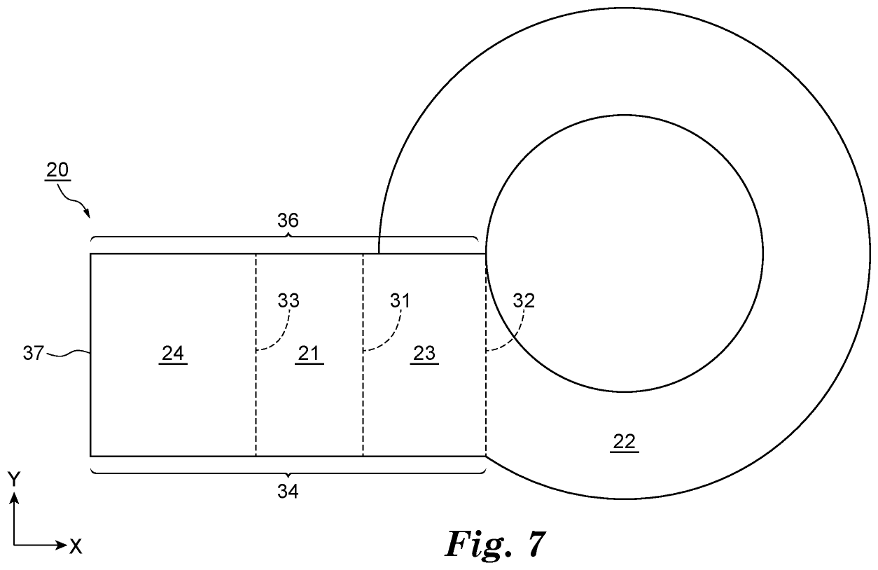

For example, the heat insulating sheet member 20 illustrated in FIGS. 7 to 9 may be adopted. In the heat insulating sheet member 20 illustrated in FIGS. 7 to 9, the region 22 is elongated into an arc shape along the scroll portion 14 of the bottom wall portion 7. According to such a configuration, the region 22 can enhance the heat insulation property not only in the vicinity of the terminating end portion 14a, but across a wide range of the scroll portion 14.

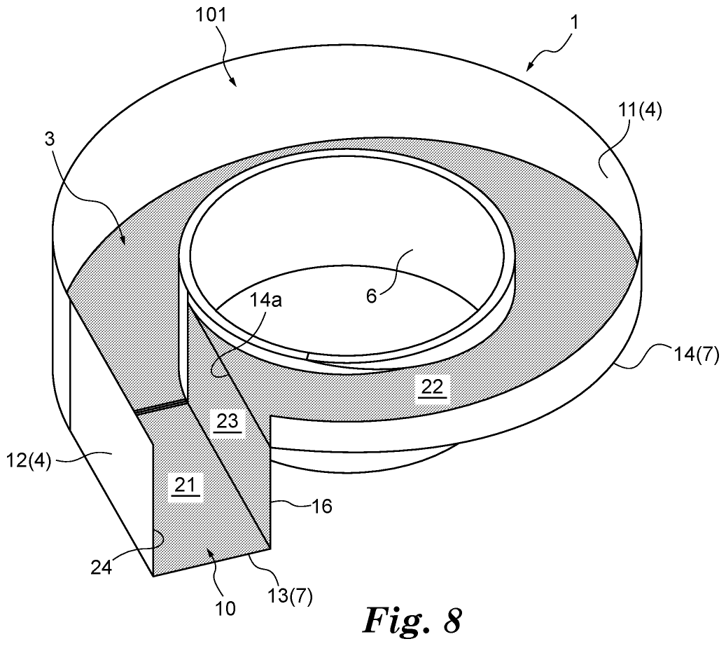

The region 22 illustrated in FIG. 7 includes an end portion on the upstream side that reaches the side portion 36. Note that the side portion 36 and the end portion on the upstream side of the region 22 are disconnected. Further, as illustrated in FIG. 8, in a case that the heat insulating sheet member 20 illustrated in FIG. 7 is incorporated into the turbine housing 1, the region 22 covers substantially the entire area of the scroll portion 14.

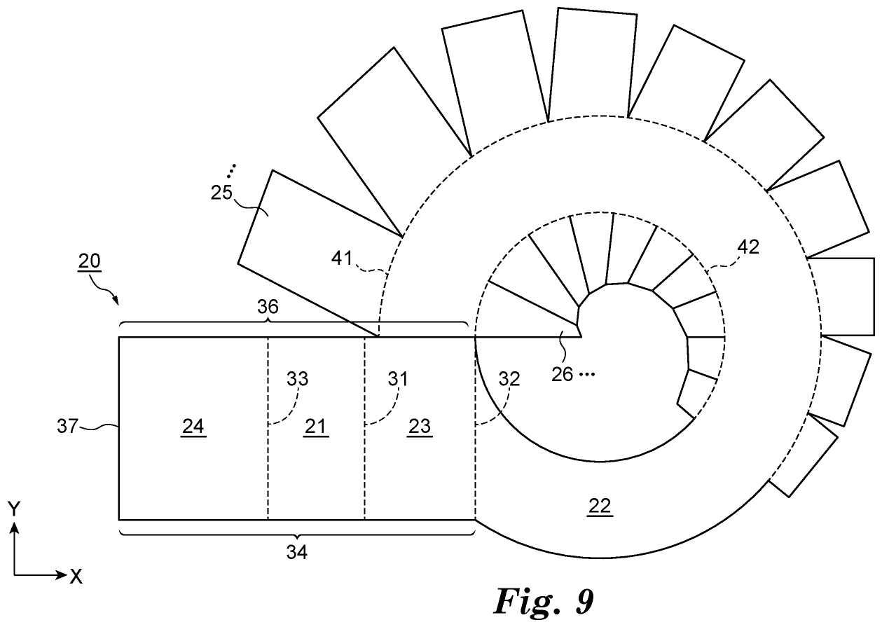

The heat insulating sheet member 20 illustrated in FIG. 9 may further include a region (fifth region) 25 provided radially extending from the region 22 having an arc shape to an outer peripheral side and corresponding to a portion of the outer peripheral wall portion 4 further downstream of the exhaust gas introduction flow path 101 than a location corresponding to the region 24. A plurality of the regions 25 are provided continuously on an edge portion on the outer peripheral side of the region 22. Further, the region 25 is bent at a boundary portion 41 between the region 25 and the region 22 so as to extend upward to the top side. According to such a configuration, the heat insulation property of the outer peripheral wall portion 4 can be enhanced across a wide range along the scroll portion 14.

Further, the heat insulating sheet member 20 illustrated in FIG. 9 may further include a region (sixth region) 26 provided extending from the region 22 having an arc shape to an inner peripheral side and corresponding to a portion of the inner peripheral wall portion 6 further downstream of the exhaust gas introduction flow path 101 from the coupling wall portion 16. A plurality of the regions 26 are provided continuously on an edge portion on the inner peripheral side of the region 22. Further, the region 26 is bent at a boundary portion 42 between the region 26 and the region 22 so as to extend upward to the top side. According to such a configuration, the heat insulation property of the inner peripheral wall portion 6 can be enhanced across a wide range along the scroll portion 14.

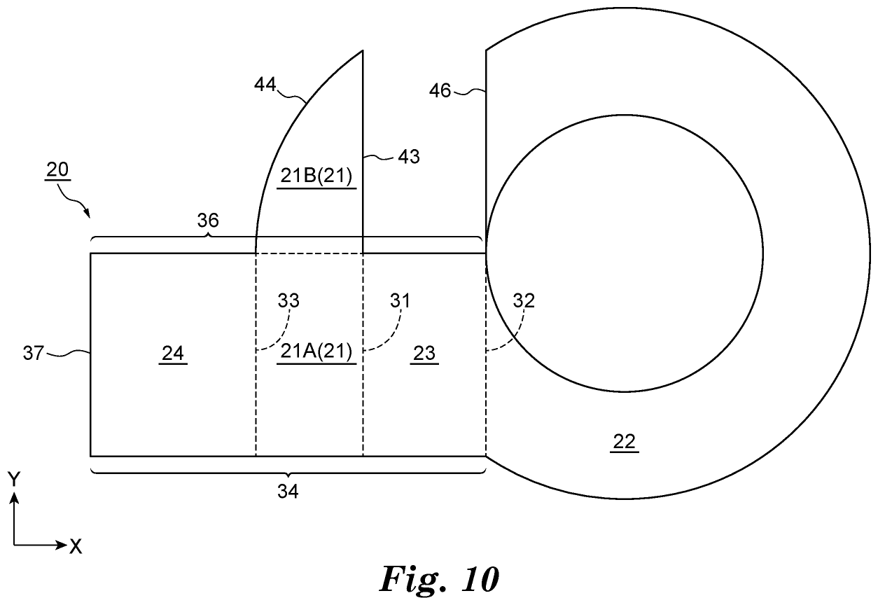

Further, as illustrated in FIGS. 10 to 15, the heat insulating sheet member 20 can be adopted in which the area of the continuous portion of the inorganic flexible material can be increased in the vicinity of the exhaust gas introduction portion 10. In the heat insulating sheet member 20 illustrated in FIGS. 10 to 15, the region 22 includes an expansion region (first expansion region) 21B. The expansion region 21B is provided protruding from a region 21A corresponding to the inlet 13 of the region 21 and corresponds to a portion of the bottom wall portion 7 downstream of the exhaust gas introduction flow path 101 relative to the inlet 13. According to such a configuration, the heat insulation property can be enhanced by covering a portion further downstream than the inlet 13 with the expansion region 21B. Further, with the addition of the expansion region 21B to the region 21A, the area of the continuous portion of the inorganic flexible material in the vicinity of the exhaust gas introduction portion 10 can be increased, making it possible to improve the workability of attachment of the heat insulating sheet member 20 to the vicinity of the exhaust gas introduction portion 10. Note that the region 21A has the same configuration as that of the region 21 in FIG. 4.

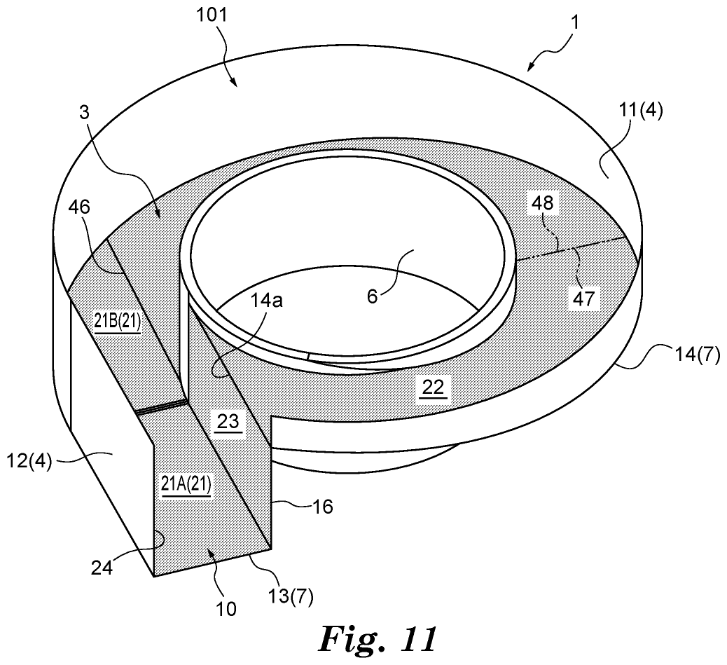

The heat insulating sheet member 20 illustrated in FIG. 10 includes the expansion region 21B protruding downstream from the side portion 36 relative to the region 21A. The expansion region 21B of FIG. 10 includes an end portion 43 that extends straight from the boundary portion 31 to a positive side in the Y-axis direction and an end portion 44 that curves from the boundary portion 33 along the shape of the outer peripheral wall portion 4. Further, the end portion 46 on the upstream side of the region 22 extending in an arc shape is disposed at a position spaced apart from the region 23 and is configured to extend straight from the boundary portion 32 to the positive side in the Y-axis direction. As illustrated in FIG. 11, in a case that the heat insulating sheet member 20 illustrated in FIG. 10 is incorporated into the turbine housing 1, the expansion region 21B covers the portion of the scroll portion 14 in the vicinity of the boundary with the inlet 13. The portion of the bottom wall portion 7 located closer to the guide 12 than the coupling wall portion 16 is covered by the regions 21A, 21B. The region 22 covers a portion of the scroll portion 14 downstream from the region 21B.

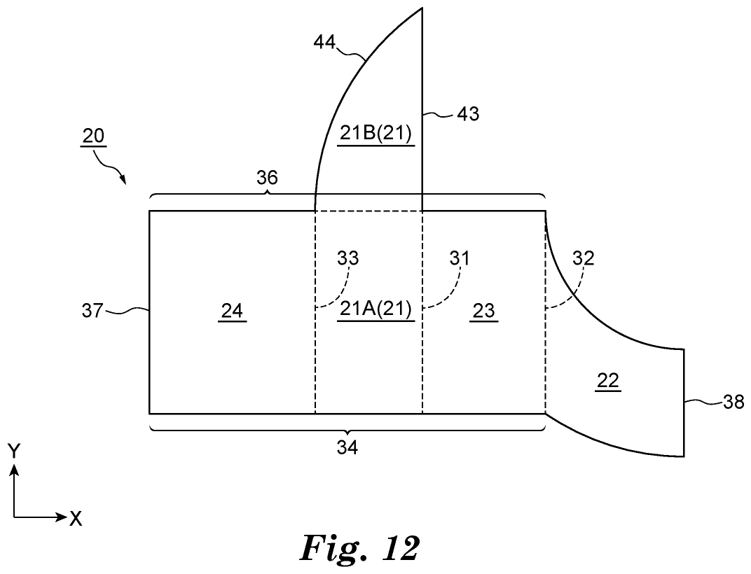

Note that, as in the heat insulating sheet member 20 illustrated in FIG. 12, a configuration may be adopted in which only the expansion region 21B is added to the structure of FIG. 4.

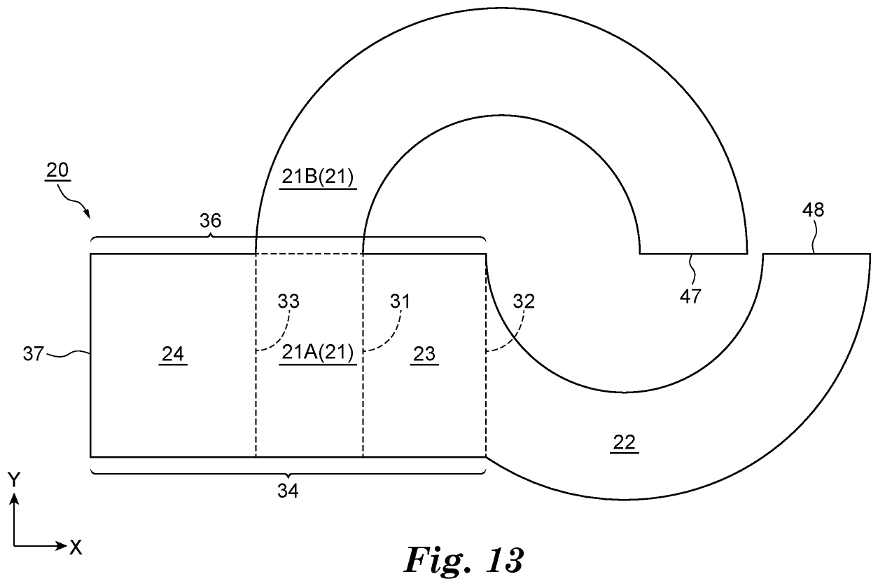

The heat insulating sheet member 20 illustrated in FIG. 13 includes the expansion region 21B elongated into an arc shape along a region upstream from the scroll portion 14. On the other hand, the length of the region 22 having an arc shape is set shorter than the length of the region 22 such as illustrated in FIG. 10. An end portion 47 on the downstream side of the expansion region 21B and an end portion 48 on the upstream side of the region 22 are disposed in the Y-axis direction at the same position as the side portion 36 in the drawing. Further, the end portions 47, 48 extend straight in the X-axis direction. In a case that the heat insulating sheet member 20 illustrated in FIG. 13 is incorporated into the turbine housing 1, the expansion region 21B and the region 22 cover substantially the entire area of the scroll portion 14. Note that the end portion 47 and the end portion 48 are disposed so as to face each other at a position midway on the scroll portion 14 (refer to the imaginary line in FIG. 11).

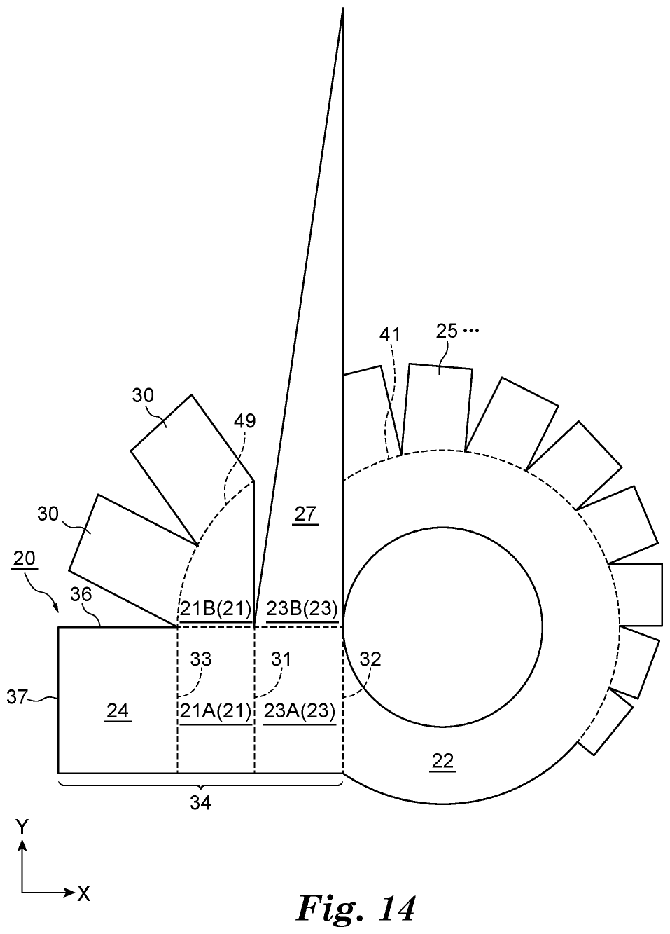

In contrast to the configuration illustrated in FIG. 10, the heat insulating sheet member 20 illustrated in FIG. 14 further includes the region 25 that extends radially from the region 22 having an arc shape to the outer peripheral side and covers the outer peripheral wall portion 4. Further, in contrast to the configuration illustrated in FIG. 10, the heat insulating sheet member 20 illustrated in FIG. 14 further includes an expansion region 30 that extends radially from an end portion on the outer peripheral side of the expansion region 21B and covers the outer peripheral wall portion 4. The expansion region 30 is bent at a boundary portion 49 so as to extend upward to the top side from the expansion region 21B. Further, in the heat insulating sheet member 20 illustrated in FIG. 14, the region 23 includes an expansion region (third expansion region) 23B. The expansion region 23B is provided extending from a region 23A of the third region 23 corresponding to the coupling wall portion 16 and corresponds to a portion of the inner peripheral wall portion 6 extending downstream of the exhaust gas introduction flow path 101 from the coupling wall portion 16. The expansion region 23B can cover substantially the entire area of the portion of the inner peripheral wall portion 6 that protrudes above the scroll portion 14. As a result, the heat insulation property of the inner peripheral wall portion 6 can be enhanced across a wide range along the scroll portion 14. Note that the region 23A has the same configuration as that of the region 23 illustrated in FIG. 4.

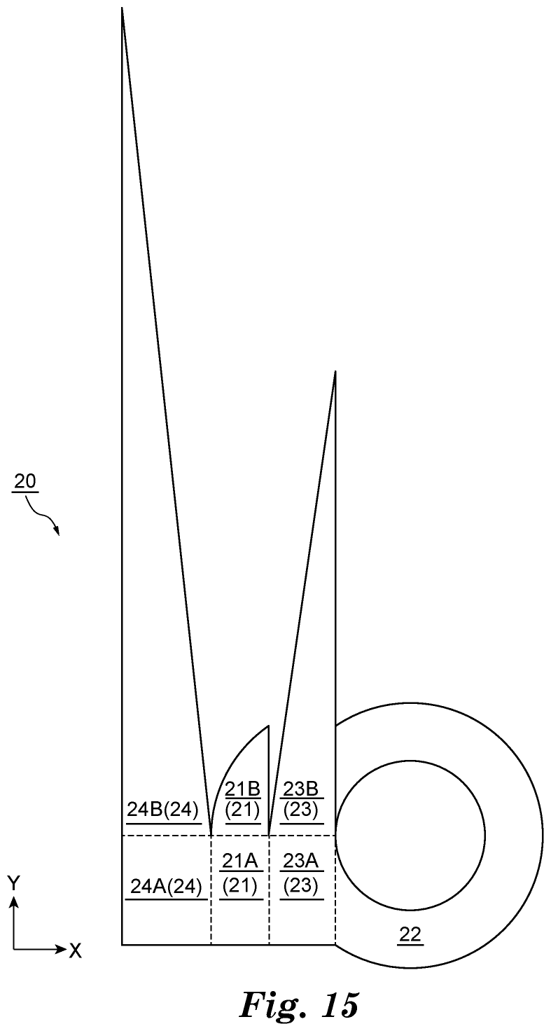

The heat insulating sheet member 20 illustrated in FIG. 15, in contrast to the configuration illustrated in FIG. 14, is without the regions 25, 30. Further, in the heat insulating sheet member 20 illustrated in FIG. 15, the region 24 includes an expansion region (fourth expansion region) 24B. The expansion region 24B is provided extending from an adjacent region 24A of the region 24 adjacent to the region 21 and farthest upstream in the exhaust gas introduction flow path 101 and corresponds to a portion of the outer peripheral wall portion 4 further downstream of the exhaust gas introduction flow path 101 than a location corresponding to the adjacent region 24A. The expansion region 24B can cover substantially the entire area of the pivoting portion 11 of the outer peripheral wall portion 4. As a result, the heat insulation property of the outer peripheral wall portion 4 can be enhanced across a wide range along the scroll portion 14. In a case that the heat insulating sheet member 20 illustrated in FIG. 15 is incorporated into the turbine housing 1, substantially the entire area of the inner surface of the turbine housing 1 can be covered. The adjacent region 24A is a region directly bonded and thus adjacent to the region 21, and has the same configuration as that of the region 24 in FIG. 4.

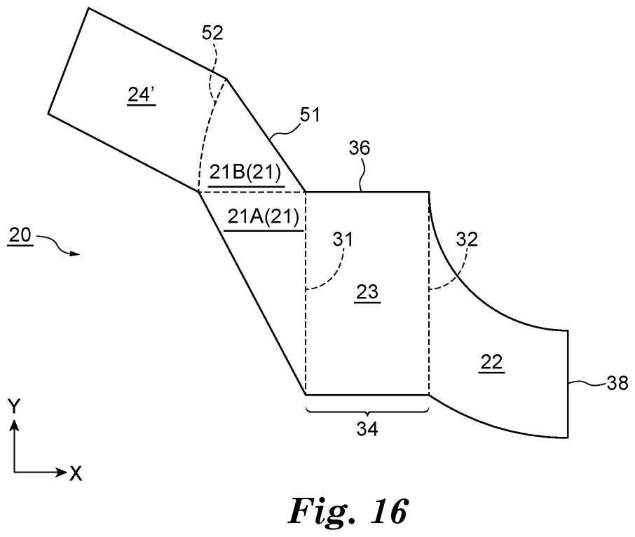

Note that in the embodiments and modified examples described above, the region 24 (the region 24 in a case that the adjacent region 24A and the expansion region are not included) is disposed in the same position in the Y-axis direction as the region 21 (the region 21 in a case that the region 21A and the expansion region are not included) and the region 23 (the region 23 in a case that the region 23A and the expansion region are not included). That is, the region 24 is configured to cover the guide 12 of the outer peripheral wall portion 4. However, no particular limitation is placed on how the region 24 is coupled to the region 21. For example, a configuration such as illustrated in FIG. 16 may be adopted. The heat insulating sheet member 20 illustrated in FIG. 16 includes a region (fourth region) 24′ disposed at a position offset downstream from the region 23 and the region 21A. In this case, the region 24′ is coupled to the region 21 with the expansion region 21B therebetween. Further, a boundary portion 52 (similar to the boundary portion 49 in FIG. 14) is provided at a position corresponding to a connecting portion between the bottom wall portion 7 and the outer peripheral wall portion 4. As described above, the portion in the region 21 coupled to the “fourth region” in the claims need not be configured to include only the region 21A corresponding to the inlet 13, but may be coupled to the “fourth region” with the expansion region 21B therebetween. The region covering the outer peripheral wall portion 4 disposed farthest upstream corresponds to the “fourth region” in the claims. Thus, the expansion region 30 illustrated in FIG. 14 does not correspond to the “fourth region”.

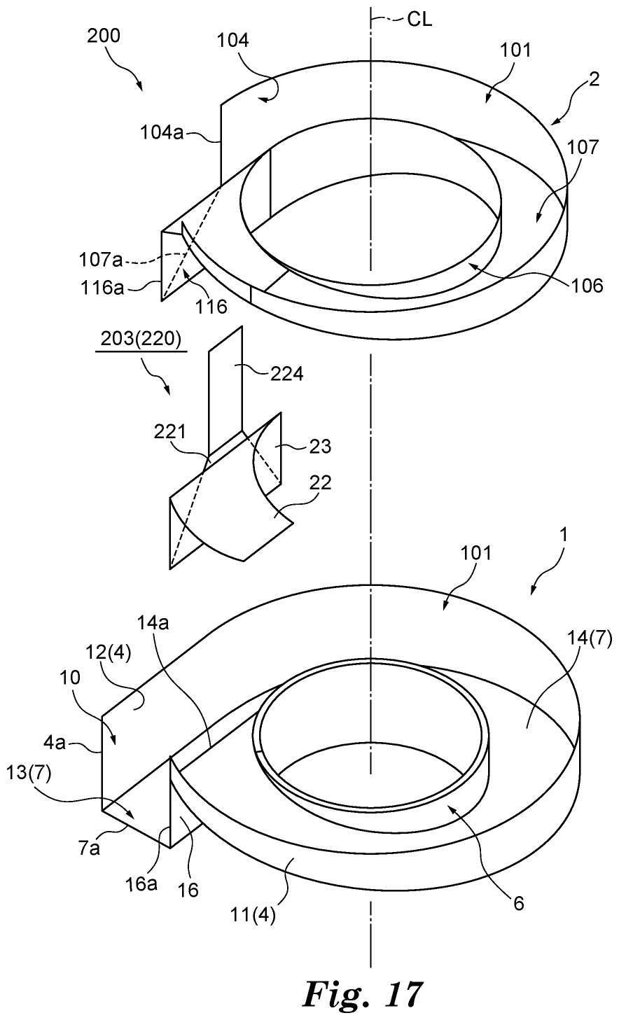

Further, in the embodiment described above, the inner shell has a shape corresponding to the outer shell. Accordingly, the heat insulating sheet member has a shape corresponding to both the outer shell and the inner shell. However, the shape in the vicinity of the inlet of the inner shell can differ from the shape in the vicinity of the inlet of the outer shell. In this case, the heat insulating sheet member has a shape corresponding to the inner shell. Specifically, as illustrated in FIG. 17, the edge portion 107a of the inner shell bottom wall portion 107 of an inner shell 200 has a shape that inclines downstream from the inner peripheral side toward the outer peripheral side. The edge portion 104a of the inner shell outer peripheral wall portion 104 is disposed downstream from an edge portion 4a of the outer peripheral wall portion 4. In this case, a heat insulating portion 203 constituted by a heat insulating sheet member 220 corresponds to the shape of the inner shell 200. That is, a region 221 corresponding to the edge portion 107a of the heat insulating sheet member 220 has a shape that inclines downstream from the inner peripheral side toward the outer peripheral side.

Note that the configuration of the turbine housing is not limited to the objects described in the above-described embodiments and modified examples, and the turbine housing may be configured as appropriate within a range that does not alter the spirit thereof. For example, the present invention is suitable for a configuration such as a housing having a structure in which a scroll is divided and used in a variable turbocharger, a variable nozzle turbo, a variable geometry turbo system, and the like.

1. A structure for exhausting gas from an internal combustion engine, the structure comprising a housing and an inner shell forming an exhaust gas introduction flow path, wherein the structure is characterized by further comprising:
a heat insulating sheet member configured as a bendable member formed from an inorganic flexible material and being disposed between the housing and the inner shell,
the housing including an outer peripheral wall portion and an inner peripheral wall portion extending along a central axis, and a bottom wall portion provided on a first side in an axial direction, the axial direction being an extending direction of the central axis, an exhaust gas introduction portion being formed in a portion of the outer peripheral wall portion in a circumferential direction and configured to introduce exhaust gas into the housing, the bottom wall portion including an inlet of the exhaust gas introduction flow path formed at a position corresponding to the exhaust gas introduction portion in the circumferential direction, and a scroll portion extending in a spiral manner about the central axis from an upstream side to a downstream side of the exhaust gas introduction flow path, the scroll portion including a terminating end portion disposed on a second side in the axial direction from the inlet, and the terminating end portion of the scroll portion and the inlet being coupled by a coupling wall portion extending in the axial direction,
the inner shell being disposed on an inner side of the housing and including an inner shell outer peripheral wall portion, an inner shell inner peripheral wall portion, an inner shell bottom wall portion, and an inner shell coupling wall portion corresponding to the outer peripheral wall portion, the inner peripheral wall portion, the bottom wall portion, and the inner shell coupling wall portion of the housing, and
the heat insulating sheet member comprising:
a first region corresponding to at least an edge portion on an inlet side of the exhaust gas introduction flow path in the inner shell bottom wall portion;
a second region corresponding to at least the terminating end portion of the scroll portion;
a third region provided between the first region and the second region and corresponding to at least the coupling wall portion; and
a fourth region corresponding to at least an edge portion on the inlet side of the exhaust gas introduction flow path in the inner shell outer peripheral wall portion,
wherein the first region and the third region, the third region and the second region, and the first region and the fourth region are coupled to each other with the inorganic flexible material in a continuous state.

2. The structure according to claim 1, wherein the first region includes a first expansion region, and the first expansion region is provided protruding from a region corresponding to the inlet of the first region and corresponds to a portion of the bottom wall portion downstream of the exhaust gas introduction flow path relative to the inlet.

3. The structure according to claim 1, wherein the second region extends in an arc shape along the scroll portion of the bottom wall portion.

4. The structure according to claim 1, wherein the fourth region includes a fourth expansion region, and the fourth expansion region is provided extending from an adjacent region of the fourth region adjacent to the first region and corresponds to a portion of the outer peripheral wall portion further downstream of the exhaust gas introduction flow path than a location corresponding to the adjacent region.

5. The structure according to claim 1, wherein the third region includes a third expansion region, and the third expansion region is provided extending from a region of the third region corresponding to the coupling wall portion and corresponds to a portion of the inner peripheral wall portion extending downstream of the exhaust gas introduction flow path from the coupling wall portion.

6. The structure according to claim 3, further comprising:
a fifth region provided radially extending from the second region having an arc shape to an outer peripheral side and corresponding to a portion of the outer peripheral wall portion further downstream of the exhaust gas introduction flow path than a location corresponding to the fourth region.

7. The structure according to claim 3, further comprising:
a sixth region provided extending from the second region having an arc shape to an inner peripheral side and corresponding to a portion of the inner peripheral wall portion extending from the coupling wall portion to the downstream side of the exhaust gas introduction flow path.

8. The structure according to claim 1, wherein the housing is a turbine housing.

9. The structure according to claim 8, wherein the exhaust gas introduction flow path is of a turbocharger.

10-12. (canceled)

13. The structure according to claim 2, wherein the second region extends in an arc shape along the scroll portion of the bottom wall portion.

14. The structure according to claim 2, wherein the fourth region includes a fourth expansion region, and the fourth expansion region is provided extending from an adjacent region of the fourth region adjacent to the first region and corresponds to a portion of the outer peripheral wall portion further downstream of the exhaust gas introduction flow path than a location corresponding to the adjacent region.

15. The structure according to claim 3, wherein the fourth region includes a fourth expansion region, and the fourth expansion region is provided extending from an adjacent region of the fourth region adjacent to the first region and corresponds to a portion of the outer peripheral wall portion further downstream of the exhaust gas introduction flow path than a location corresponding to the adjacent region.

16. The structure according to claim 2, wherein the third region includes a third expansion region, and the third expansion region is provided extending from a region of the third region corresponding to the coupling wall portion and corresponds to a portion of the inner peripheral wall portion extending downstream of the exhaust gas introduction flow path from the coupling wall portion.

17. The structure according to claim 3, wherein the third region includes a third expansion region, and the third expansion region is provided extending from a region of the third region corresponding to the coupling wall portion and corresponds to a portion of the inner peripheral wall portion extending downstream of the exhaust gas introduction flow path from the coupling wall portion.

18. The structure according to claim 4, wherein the third region includes a third expansion region, and the third expansion region is provided extending from a region of the third region corresponding to the coupling wall portion and corresponds to a portion of the inner peripheral wall portion extending downstream of the exhaust gas introduction flow path from the coupling wall portion.

19. The structure according to claim 13, further comprising:
a fifth region provided radially extending from the second region having an arc shape to an outer peripheral side and corresponding to a portion of the outer peripheral wall portion further downstream of the exhaust gas introduction flow path than a location corresponding to the fourth region.

20. The structure according to claim 14, further comprising:
a fifth region provided radially extending from the second region having an arc shape to an outer peripheral side and corresponding to a portion of the outer peripheral wall portion further downstream of the exhaust gas introduction flow path than a location corresponding to the fourth region.

21. The structure according to claim 13, further comprising:
a sixth region provided extending from the second region having an arc shape to an inner peripheral side and corresponding to a portion of the inner peripheral wall portion extending from the coupling wall portion to the downstream side of the exhaust gas introduction flow path.

22. The structure according to claim 14, further comprising:
a sixth region provided extending from the second region having an arc shape to an inner peripheral side and corresponding to a portion of the inner peripheral wall portion extending from the coupling wall portion to the downstream side of the exhaust gas introduction flow path.
